(19) United States
(12) Patent Application Publication
(10) Pub. No.: US 2015/0168994 A1
(43) Pub. Date: Jun. 18, 2015

(54) SECURE CAGE CREATED BY RE-DISTRIBUTION LAYER METALLIZATION IN FAN-OUT WAFER LEVEL PACKAGING PROCESS

(71) Applicant: CIRQUE CORPORATION, Salt Lake City, UT (US)

(72) Inventor: Jared G. Bytheway, Sandy, UT (US)

(73) Assignee: CIRQUE CORPORATION, SALT LAKE CITY, UT (US)

(21) Appl. No.: 14/571,121

(22) Filed: Dec. 15, 2014

Related U.S. Application Data
(60) Provisional application No. 61/915,940, filed on Dec. 13, 2013.

(51) Int. Cl. G06F 1/16; G06F 3/041; G06F 3/044

(52) U.S. Cl. CPC G06F 1/16; G06F 3/044; G06F 3/0416; G06F 2203/04112; G06F 2203/04107

(57) ABSTRACT

A system and method for disposing a secure conductive mesh into an encapsulant material of an integrated circuit package to thereby at least partially physically surround dies within the integrated circuit packages, circuit pathways and other components in order to physically protect secure data from being probed by a device that alters a capacitance signal from the secure mesh.

### BACKGROUND OF THE INVENTION

1. Field of the Invention

This invention relates generally to applications requiring security for sensitive data in which it is necessary to physically secure data lines and integrated circuits that carry sensitive or confidential information. More specifically, the present invention may be applied to touch sensors and secure digital communication pathways between components in a touch sensor that enable the secure entry of data to and/or from a touch sensor. The present invention may modify a die package around a silicon wafer during the time of manufacture.

2. Description of Related Art

There are several designs for capacitance sensitive touch sensors. It is useful to examine the underlying technology of at least one design to better understand how a capacitance sensitive touchpad may be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

Previous technology for securing a touch sensor may be directed to the concept of protecting an operating volume. An operating volume may be a space within which a touch sensor and its components such as touch sensing circuitry are disposed. Thus, an operating volume may be a housing of a point-of-sale (POS) terminal. A touch sensor and its touch sensing circuitry may be disposed within the housing of the POS terminal. Electrodes may be disposed around the inside of the POS terminal in order to sense the space within the POS terminal and look for the entry of probes that change the operating volume. If there are changes within the POS terminal such as a probe or other object that is penetrating the POS terminal in order to insert an electrode for intercepting communication from the touch sensor or any other circuitry with which the touch sensor may communicate, the probe may be detected.

It would be an advantage to create a process that may be performed during manufacturing of an integrated circuit and circuit pathways between integrated circuits in order to integrate protections into the covering of the silicon wafer of the integrated circuits and around circuit pathways.

### BRIEF SUMMARY OF THE INVENTION

In a preferred embodiment, the present invention is a system and method for disposing a secure conductive mesh into an encapsulant material of an integrated circuit package to thereby at least partially physically surround dies within the integrated circuit packages, circuit pathways and other components in order to physically protect secure data from being probed by a device that alters a capacitance signal from the secure mesh.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

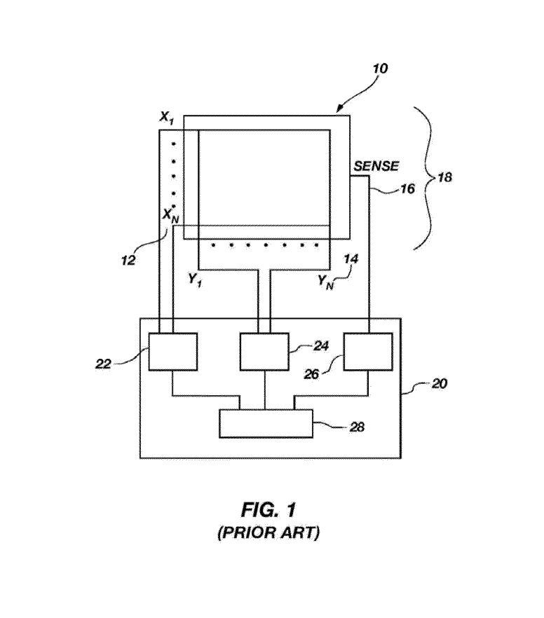

FIG. 2 is a cut-away profile view of an integrated circuit package comprised of two integrated circuits, a first encapsulant on a first side, a second side with a second encapsulant and having a re-distribution layer and a protective mesh disposed within the second encapsulant.

FIG. 3 is a cut-away profile view of an integrated circuit package comprised of two integrated circuits, a first encapsulant on a first side, a second side with a second encapsulant and having a re-distribution layer and a protective mesh disposed within the second encapsulant, and then another encapsulant disposed on the first side of the integrated circuit package that includes another re-distribution layer and a protective mesh.

FIG. 4 is a block diagram of secure mesh of integrated circuit packages coupled to a capacitance measurement circuit.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document includes any capacitive touch sensor device, including touchpads, touch screens and touch panels, and includes proximity and touch sensing capabilities.

It should be understood that any silicon that may be used to form an integrated circuit that is packaged according to any industry standards, or which is connected to any other integrated circuits or components in an electrical circuit may be protected using the method of the present invention.

At least one embodiment of the present invention may be directed to detection of a probe that is in proximity of or making direct contact with package that is housing an integrated circuit. At least one embodiment may also be directed to detection of a probe or other device that may attempt to intercept signals on a circuit pathway or other electrode that is carrying information within the integrated circuit housing. The circuit pathway may also be external to the integrated circuit housing and may transmit data between any two points in an electrical circuit.

The embodiments of the present invention are directed to making a system of circuit pathways and integrated circuits tamper resistant. Accordingly, the embodiments are directed to the protection of secure data, where secure data may include but should not be considered limited to confidential information, secure information, sensitive information, financial information and any other information or data that may benefit from being protected from interception, and may be referred to interchangeably in this document as “secure information” or “secure data”. The embodiments of the present invention may also be directed to electrical circuits that store, process or transfer the secure data. The electrical circuits or secure circuits may include integrated circuits, circuit pathways, or both.

When using secure data in an electrical circuit, there may be a need to move sensitive but unencrypted information from one point to another. One way to accomplish this task is to install a metal box or a layered circuit board around an electrical circuit. This solution may be large, costly and deficient in effectiveness.

The first embodiment of the present invention may provide a tamper responsive secure cage to secure integrated circuits or circuit pathways within the integrated circuit by enclosing them in a protective, conductive or secure mesh. The secure mesh may surround integrated circuits that contain secure data by disposing the secure mesh within the packaging of an integrated circuit during manufacturing.

Another aspect of this first embodiment is that other items may be disposed in the secure mesh besides secure data. Other items may include but should not be considered as limited to an LED indicator that indicates that an electrical circuit or a portion of the electrical circuit is in a secure mode of operation. Other items include a buzzer or other audio generating device, a diode that is not a light emitting diode and a switch.

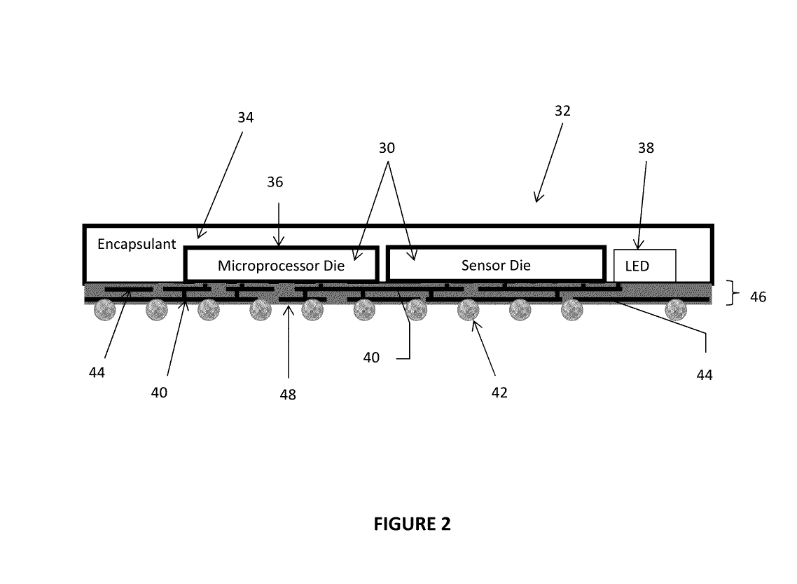

FIG. 2 is a cross-sectional profile view of a first embodiment of the present invention and shows a completed integrated circuit package that may be referred to as Fan-Out Wafer Level Packaging (FOWLP). FOWLP may be a system and method of manufacturing a secure integrated circuit.

The process to be described explains how the completed integrated circuit package is manufactured using the system and method of the present invention. The first step is to place bare and cut silicon die 30 face down in a tray, where the face 36 of the die 30 is shown turned over in this completed diagram.

If there is more than one die within the integrated circuit package, then the die 30 may be spaced apart as is commonly done. It should be realized that the first embodiment may be used regardless of the number of die 30 within a single integrated circuit package 32. FIG. 2 shows that in this example, there is a microprocessor die and a sensor die within the same integrated circuit package 32.

Before the next step, it may be preferred to place other components in the tray that will become part of the integrated circuit package. These other components may include such items as an LED 38 or other previously mentioned items that may need to be secure.

Assuming for this example that there are at least two die 30 and an LED 38 within the integrated circuit package 32, the next step may be to pour an encapsulant material 34 that may contain silicon aggregate or any other type of appropriate encapsulate over the die 30 in the tray.

The next step may be to allow the encapsulant material 34 within the tray to cure. After curing, standard integrated circuit manufacturing processes may be performed in order to place circuit pathways 40 between the die 30, to other components if they are present, and to any pins that may be used to provide access to the die 30 from outside the integrated circuit package 32. The circuit pathways 40 may be placed within the encapsulant and on the outside of the encapsulant. The creation of the circuit pathways 40 may be referred to as creation of re-distribution layers (RDL) 46. FIG. 2 shows only two distinct re-distribution layers 46 but there may be any number of re-distribution layers 46 within an integrated circuit package.

Interspersed in each of the re-distribution layers 46 is the secure mesh 44 as shown in FIG. 2. Thus, there may be many discrete segments of secure mesh 44 within the re-distribution layers 46. The secure mesh may be disposed adjacent to the circuit pathways 40 and to the dies 30. The secure mesh 44 may be coupled together or they may be left as discrete electrically floating segments 44, or a combination of the two. It is preferred that all the segments of the secure mesh 44 be electrically coupled together so that they may be monitored in order to detect intrusion of a probe. It may not be possible to detect where the secure mesh 44 is disposed within the re-distribution layers 46 from outside the integrated circuit package 32.

A next step may be to dispose solderballs 42 on the outside of the integrated circuit package 42 and on a connection side 48. The result may be a standardized looking ball grid array (BGA) integrated circuit package 42. If more than one die is needed in the integrated circuit package 42, then connecting circuit pathways 40 may be applied.

One or more layers of secure mesh 44 may be achieved in the re-distribution layers 46 in a FOWLP to protect secure components. However, as shown in FIG. 2, this technique may only secure one side, a circuit side, of the integrated circuit package 42. The opposite side of the integrated circuit package 42 may only be somewhat secured in that probing would have to go through the original die or through the encapsulant material 34 depending on an attack point.

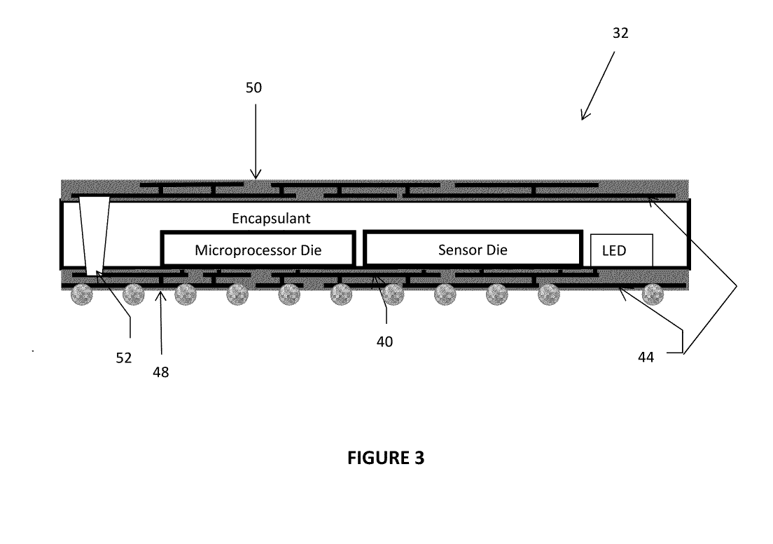

FIG. 3 is a cross-sectional profile view of a second embodiment of the present invention. The method and system shown in FIG. 3 may be used to secure the entire contents of the integrated circuit package 32 within the encapsulant material 34.

In this second embodiment, a backside 50 of the integrated circuit package 32 may be processed with re-distribution layers 46 of the secure mesh 44 as well. Accordingly, the manufacturing process may be modified by disposing the secure mesh 44 within the tray before the die 30 are placed within it and on top of the secure mesh.

In order to connect all of the individual segments of the secure mesh 44, it may be necessary to provide a circuit pathway between the connection side 48 and the backside 50 of the integrated circuit package 32. The circuit pathway between the secure mesh 44 on the connection side 48 and the backside 50 may be a thru package via or vias 52. The thru package vias 52 may be formed using laser drilling, chemical etching or by using planted pillars through the encapsulant material 34 to connect both sides of the re-distribution layers 46.

The embodiments of the present invention may include the concepts of protecting secure data and secure circuits using the creation of re-distribution layers 46 and the FOWLP process on the connection side 48 of integrated circuit packages 32. The embodiments may also include protecting secure data and secure circuits using the creation of re-distribution layers 46 and the FOWLP process on the connection side 48 and the backside 50 using thru package vias 52 in the integrated circuit packages 32.

The embodiments may also provide secure components such as the LED 38 in the integrated circuit packaging 32 so as to signify to the user that information is secure. Furthermore, if there are multiple integrated circuit packages 32 being protected, the status of each of the protected integrated circuits may be indicated using a plurality of LEDs 38. Finally, the LEDs 38 may also be secured so that they may not be tampered with.

The embodiments of the present invention may also include the concept of a light pipe that may be included in the integrated circuit package 32 to bring a light from an LED 38 out of the integrated circuit package.

In another embodiment of the invention, power supply filters may also be included in the integrated circuit package 32 to aid in reducing sensitive data leakage via input power or radiated energy.

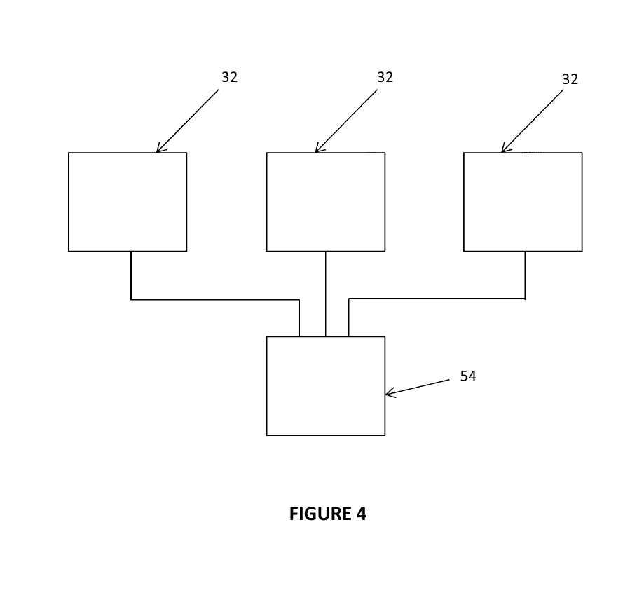

FIG. 4 shows that the embodiments of the invention may include the concept of connecting the individual secure mesh 44 segments together. FIG. 4 is a block diagram that shows three integrated circuit packages 32 all being coupled to a capacitance measurement circuit 54. More specifically, the secure mesh 44 of the of the integrated circuit packages 32 is coupled to the capacitance measurement circuit 54.

In an alternative embodiment, the secure mesh 44 of each of the integrated circuit packages 32 may also be coupled to sudden destruct input pins. Any changes in the capacitance in or very near the integrated circuit packages 32 may be detected and a tamper signal may be activated that results in a signal being sent to the affected integrated circuit packages 32 on an input pin that includes the ability to erase secure data in one or all of the integrated circuit packages.

The present invention may also include the concept of taking baseline capacitance measurements from the secure mesh 44 of each of the integrated circuit packages 32. The baseline measurements may be used to compare with subsequent capacitance measurements being used to determine if a probe is entering into a detection range of the secure mesh 44. If the capacitance measurements are different, then it may be known that the system has been compromised and appropriate measures may then be performed to secure the system. These steps may include such things as erasing secure data or disabling the integrated circuit packages 32 that contain secure data.

The capacitance measurement circuit 54 may be a part of a touch sensor that is used for a touch sensor associated with a system that is using the integrated circuit packages 32. The capacitance measurement circuit 54 may be capable of transmitting a signal to alert or warn of the presence of the probe. The capacitance measurement circuit 54 may be capable of stopping the transmission of secure data within an integrated circuit package 32 or between components that may be communicating at some time with the integrated circuit package. The capacitance measurement circuit 54 may also transmit a signal to another device that stops transmission of the secure data on the circuit pathways.

The present invention may be capable of detecting the presence of a probe on or near a single circuit pathway 40 that may transmit secure data, or on a plurality of circuit pathways 40.

One application of the present invention may be in a financial transaction. A user may have to enter a personal identification number (PIN) on a touch screen of a Point of Sale (POS) terminal. The PIN data may have to be transmitted from the touch screen in order to confirm the accuracy of the PIN data. The touch screen may include a capacitance measurement circuit 54 that may need to transmit the data to another component within the POS terminal in order to verify PIN data.

Payment industry standards may require protecting PIN data from being accessible by a probe that may try to capture signals from the touch screen. Typically the integrated circuits and electrodes for connecting a touch controller IC (capacitance measurement circuit 54) and microprocessor are housed in a Tamper Resistant Security Module. However, the present invention now provides an additional layer of security.

The present invention may now monitor circuit pathways transmitting digital communication signals by encasing the circuit pathways with the embodiments of the invention described above, and then periodically measuring circuit pathways including the dielectric between the electrodes being protected and other nearby electrodes that may be strategically placed to sense changes in material such as etching, chipping or adding conductive inks, etc. The embodiments of the present invention may be used to detect any leakage of current or change in bulk capacitance of the protected circuit pathways.

The embodiments of the present invention may also be used to monitor other circuit pathways that may not necessarily be associated with the capacitance measurement circuit 54 communications such as to protect contact card connector and electrodes from probing or insertion of a man-in-the-middle device left in a contact card socket.

Therefore, the embodiments of the present invention may be used to protect integrated circuit packages 32 and circuit pathways 40 from probing by following the steps of 1) enclosing integrated circuits such as microprocessor dies 30 or sensor dies 30 that may contain or process secure data in a secure mesh 44 that may partially or completely surround them, 2) enclosing the integrated circuit packages 32 and the secure mesh 44 with an encapsulant material 34. In an alternative embodiment, the system may make a capacitance measurement including bulk capacitance of the circuit pathways 40 and integrated circuit packages 32, it may record the measurement as a baseline measurement, and successively take capacitance measurements that are compared with the baseline measurement. These capacitance measurements may be made with either end of a protected circuit pathway 40 by driving high, driving low or tri-stated, etc.

The present invention is thus a method for securing an integrated circuit package 32 or circuit pathway 40 from a probe, said method comprising providing at least one component having secure data, a first encapsulant on a first side of the at least one component, a second encapsulant on the second side of the at least one component, a re-distribution layer on the second encapsulate which is coupled to the at least one component, a wire mesh for preventing tampering, and a third encapsulant over the re-distribution layer.

Connections may be made between a first component and a second component within the at least one component, and solderballs may be included to desired connection points of the re-distribution layer. Another layer of encapsulant may then be disposed over the wire mesh.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A system for protecting an integrated circuit package or circuit pathways within the integrated circuit package from a probe, said system comprised of:
at least one die;
a plurality of circuit pathways from the at least one die to at least one outside connection pin;
a secure mesh that is disposed adjacent to the at least one die and at least a portion of the plurality of circuit pathways; and
an encapsulant disposed around the at least one die, the plurality of circuit pathways and the secure mesh to thereby form an integrated circuit package.

2. The system as defined in claim 1 wherein the system is further comprised of a capacitance measurement circuit that is coupled to the secure mesh for measuring a capacitance of the secure mesh.

3. The system as defined in claim 1 wherein the system is further comprised of the secure mesh disposed on a connection side of the integrated circuit package.

4. The system as defined in claim 3 wherein the system is further comprised of:
the secure mesh disposed on a backside of the integrated circuit package opposite the connection side; and
at least one thru package via for connecting the secure mesh on the connection side and the secure mesh on the backside of the integrated circuit package.

5. The system as defined in claim 1 wherein the system is further comprised of at least one other component within the integrated circuit package that is not a die, wherein the at least one other component is selected from the group of components including a light emitting diode, an audio source and a switch.

6. A system for protecting an integrated circuit package or circuit pathways within the integrated circuit package from a probe, said system comprised of:
at least two die;
a plurality of circuit pathways between the at least two die and at least one outside connection pin;
a secure mesh that is disposed adjacent to the at least two die and at least a portion of the plurality of circuit pathways; and
an encapsulant disposed around the at least two die, the plurality of circuit pathways and the secure mesh to thereby form an integrated circuit package.

7. The system as defined in claim 6 wherein the system is further comprised of a capacitance measurement circuit that is coupled to the secure mesh for measuring a capacitance of the secure mesh.

8. The system as defined in claim 6 wherein the system is further comprised of the secure mesh disposed on a connection side of the integrated circuit package.

9. The system as defined in claim 8 wherein the system is further comprised of:
the secure mesh disposed on a backside of the integrated circuit package opposite the connection side; and
at least one thru package via for connecting the secure mesh on the connection side and the secure mesh on the backside of the integrated circuit package.

10. The system as defined in claim 6 wherein the system is further comprised of at least one other component within the integrated circuit package that is not a die, wherein the die is selected from the group of components including a light emitting diode, an audio source and a switch.

11. A method for protecting an integrated circuit package or circuit pathways within the integrated circuit package from a probe, said method comprising:
providing at least one die, a plurality of circuit pathways from the at least one die to at least one outside connection pin, a secure mesh that is disposed adjacent to the at least one die and at least a portion of the plurality of circuit pathways, an encapsulant disposed around the at least one die, the plurality of circuit pathways and the secure mesh to thereby form an integrated circuit package, and a capacitance measurement circuit that is coupled to the secure mesh for measuring a capacitance of the secure mesh;
measuring a baseline capacitance measurement from the secure mesh when no probe is present; and
making subsequent capacitance measurements from the secure mesh to determine if there is a change between the subsequent measurement and the baseline capacitance measurement.

12. The method as defined in claim 11 wherein the method further comprises disposing the secure mesh on a connection side of the integrated circuit package to thereby protect the integrated circuit package from a probe on the connection side.

13. The method as defined in claim 12 wherein the method further comprises:
disposing the secure mesh on a backside of the integrated circuit package opposite the connection side;
providing at least one thru package via for connecting the secure mesh on the connection side and the secure mesh on the backside of the integrated circuit package; and
making the subsequent capacitance measurements from the secure mesh on the connection side and the backside of the integrated circuit package.

14. The method as defined in claim 11 wherein the method further comprises adding at least one other component within the integrated circuit package that is not a die, wherein the other component is selected from the group of components including a light emitting diode, an audio source and a switch.

15. A system for protecting an integrated circuit package or circuit pathways within the integrated circuit package from a probe, said system comprised of:
at least one die;
a plurality of circuit pathways from the at least one die to at least one outside connection pin;
a secure mesh that is disposed adjacent to the at least one die and at least a portion of the plurality of circuit pathways;
a capacitance measurement circuit that is coupled to the secure mesh for measuring a capacitance of the secure mesh; and
an encapsulant disposed around the at least one die, the plurality of circuit pathways and the secure mesh to thereby form an integrated circuit package.

16. The system as defined in claim 15 wherein the system is further comprised of the secure mesh disposed on a connection side of the integrated circuit package.

17. The system as defined in claim 16 wherein the system is further comprised of:
the secure mesh disposed on a backside of the integrated circuit package opposite the connection side; and
at least one thru package via for connecting the secure mesh on the connection side and the secure mesh on the backside of the integrated circuit package.

18. The system as defined in claim 15 wherein the system is further comprised of at least one other component within the integrated circuit package that is not a die, wherein the at least one other component is selected from the group of components including a light emitting diode, an audio source and a switch.
